(19) United States
(12) Patent Application Publication
(10) Pub. No.: US 2021/0049519 A1
(43) Pub. Date: Feb. 18, 2021

(54) ELECTRIC VEHICLE (EV) CHARGING STATION MANAGEMENT

(71) Applicant: Honda Motor Co., Ltd., Tokyo (JP)

(72) Inventors: David Wong Cun, Fountain Valley, CA (US); Eri Izumi Maeda, Rancho Palos Verdes, CA (US); Satoru Shinzaki, Rancho Palos Verdes, CA (US)

(21) Appl. No.: 16/902,682

(22) Filed: Jun. 16, 2020

Related U.S. Application Data
(60) Provisional application No. 62/885,911, filed on Aug. 13, 2019.

(51) Int. Cl. G06Q 10/02; G06Q 10/06; G05B 15/02; B60L 53/67; B60L 53/66; G01S 19/51

(52) U.S. Cl. CPC G06Q 10/02; G06Q 10/06314; G06Q 10/06312; G01S 19/51; B60L 53/67; B60L 53/66; G05B 15/02

(57) ABSTRACT

Electric vehicle (EV) charging station management may include receiving a first EV charging station reservation request associated with a first EV at a first time slot, receiving a second EV charging station reservation request associated with a second EV at a second time slot, monitoring a location associated with the first EV, a location associated with the second EV, an estimated arrival time associated with the first EV, or an estimated arrival time associated with the second EV, and updating the first EV charging station reservation and the second EV charging station reservation based on the location of the first EV, the location of the second EV, the estimated arrival time associated with the first EV, or the estimated arrival time associated with the second EV, and enabling or disabling charging for the first EV based on the first EV charging station reservation.

### CROSS-REFERENCE TO RELATED APPLICATIONS

This application claims the benefit of U.S. Provisional Patent Application, Ser. No. 62/885,911 (Attorney Docket No. HRA-46063) entitled “ELECTRIC VEHICLE (EV) CHARGING STATION RESERVATION ADJUSTMENT”, filed on Aug. 13, 2019; the entirety of the above-noted application(s) is incorporated by reference herein.

### BACKGROUND

Electric vehicles (EVs) generally require charging at a charging station, for example. Frequently, charging station availability may not be guaranteed, especially at a public charging station. Once a driver reaches a charging station, the driver may need to wait a sufficient amount of time to recharge his or her EV.

### BRIEF DESCRIPTION

According to one aspect, a system for electric vehicle (EV) charging station management may include a memory, a processor, and a controller. The memory may store instructions, which when executed by the processor, cause the processor to perform receiving a first EV charging station reservation request associated with a first EV at a first time slot, receiving a second EV charging station reservation request associated with a second EV at a second time slot, monitoring a location associated with the first EV and a location associated with the second EV, and updating the first EV charging station reservation and the second EV charging station reservation based on the location of the first EV and the location of the second EV. The controller may enable or disable charging for the first EV based on the first EV charging station reservation.

The processor may monitor an estimated arrival time associated with the first EV and an estimated arrival time associated with the second EV and update the first EV charging station reservation and the second EV charging station reservation based on the estimated arrival time associated with the first EV and the estimated arrival time associated with the second EV. The processor may prioritize the first EV charging station reservation and the second EV charging station reservation based on the estimated arrival time associated with the first EV and the estimated arrival time associated with the second EV. The processor may prioritize the first EV charging station reservation and the second EV charging station reservation based on the location of the first EV and the location of the second EV. The processor may prioritize the first EV charging station reservation and the second EV charging station reservation based on a first received EV charging station reservation request of the first EV charging station reservation request and the second EV charging station reservation request. The processor may prioritize the first EV charging station reservation and the second EV charging station reservation based on historical on-time EV charging station reservation attendance. The processor may prioritize the first EV charging station reservation and a third EV based on the location of the first EV, a location of the third EV, and an estimated arrival time associated with the first EV. The third EV may have no associated EV charging station reservation request. The location associated with the first EV may be received from a global positioning system (GPS) of the first EV. The location associated with the first EV may be received from a global positioning system (GPS) of a mobile device communicatively coupled with the first EV.

A method for electric vehicle (EV) charging station management may include receiving a first EV charging station reservation request associated with a first EV at a first time slot, receiving a second EV charging station reservation request associated with a second EV at a second time slot, monitoring a location associated with the first EV and a location associated with the second EV, updating the first EV charging station reservation and the second EV charging station reservation based on the location of the first EV and the location of the second EV, and enabling or disabling charging for the first EV based on the first EV charging station reservation.

The method for EV charging station management may include monitoring an estimated arrival time associated with the first EV and an estimated arrival time associated with the second EV, and updating the first EV charging station reservation and the second EV charging station reservation based on the estimated arrival time associated with the first EV and the estimated arrival time associated with the second EV. The method for EV charging station management may include prioritizing the first EV charging station reservation and the second EV charging station reservation based on the estimated arrival time associated with the first EV and the estimated arrival time associated with the second EV. The method for EV charging station management may include prioritizing the first EV charging station reservation and the second EV charging station reservation based on the location of the first EV and the location of the second EV. The method for EV charging station management may include prioritizing the first EV charging station reservation and the second EV charging station reservation based on a first received EV charging station reservation request of the first EV charging station reservation request and the second EV charging station reservation request. The method for EV charging station management may include prioritizing the first EV charging station reservation and the second EV charging station reservation based on historical on-time EV charging station reservation attendance. The method for EV charging station management may include prioritizing the first EV charging station reservation and a third EV based on the location of the first EV, a location of the third EV, and an estimated arrival time associated with the first EV. The location associated with the first EV may be received from a global positioning system (GPS) of the first EV. The location associated with the first EV may be received from a global positioning system (GPS) of a mobile device communicatively coupled with the first EV.

According to one aspect, a system for electric vehicle (EV) charging station management may include a processor, a memory, and a controller. The memory may store instructions, which when executed by a processor, cause the processor to perform receiving a first EV charging station reservation request associated with a first EV at a first time slot, receiving a second EV charging station reservation request associated with a second EV at a second time slot, monitoring an estimated arrival time associated with the first EV and an estimated arrival time associated with the second EV, and updating the first EV charging station reservation and the second EV charging station reservation based on the estimated arrival time associated with the first EV and the estimated arrival time associated with the second EV. The controller may enable or disable charging for the first EV based on the first EV charging station reservation.

### BRIEF DESCRIPTION OF THE DRAWINGS

FIG. 1 is an exemplary component diagram of a system for electric vehicle (EV) charging station management, according to one aspect.

FIG. 2 is an exemplary component diagram of a system for electric vehicle (EV) charging station management, according to one aspect.

FIG. 3 is an exemplary flow diagram of a method for electric vehicle (EV) charging station management, according to one aspect.

FIG. 4 is an illustration of an example computer-readable medium or computer-readable device including processor-executable instructions configured to embody one or more of the provisions set forth herein, according to one aspect.

FIG. 5 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick or other storage drive. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

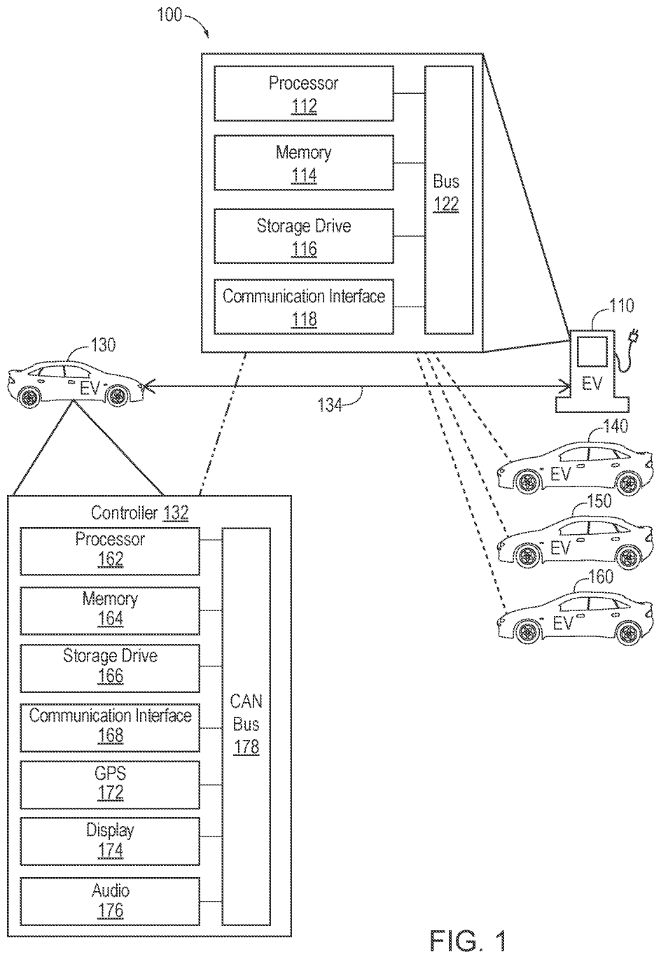

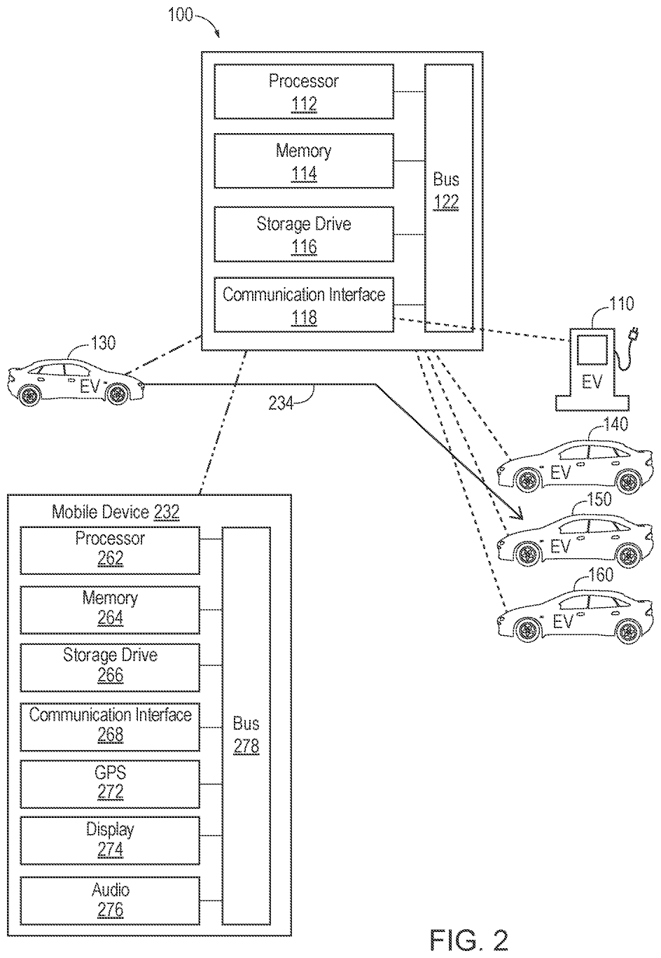

FIG. 1 is an exemplary component diagram of a system 100 for electric vehicle (EV) charging station management, according to one aspect. The system 100 for EV charging station management may be implemented at an EV charging station 110. According to another aspect, the system 100 for EV charging station management may be implemented on a server communicatively coupled to or in computer communication with the EV charging station 110, as will be described herein with respect to FIG. 2. In any event, with respect to FIG. 1, the EV charging station 110 may include a processor 112, a memory 114, a storage drive 116, a communication interface 118 which enables computer communication with the server, and a bus 122. In this way, the communication interface 118 of the EV charging station 110 may communicate with the server and one or more EVs, such as a first EV 130, a second EV 140, a third EV 150, a fourth EV 160, etc. Each one of the one or more EVs may include a controller 132 including a processor 162, a memory 164, a storage drive 166, a communication interface 168, a global positioning system (GPS) 172, a display 174 for displaying notifications associated with the system 100, an audio interface 176 receiving voice commands or providing audio notifications, and a controller area network (CAN) bus 178 communicatively coupling respective components. The memory 164 may store instructions, which when executed by the processor 162, cause the processor 162 to perform one or more actions or acts. Similarly, the memory 114 may store instructions, which when executed by the processor 112, cause the processor 112 to perform one or more actions or acts. In this way, the system 100 may be implemented at the EV charging station 110 or on the EV 130. As discussed below, if the vehicle is communicatively coupled with a mobile device, implementation of the system 100 in connection with a mobile device may be possible as well (e.g., utilizing the GPS of the mobile device or route information thereof).

According to one aspect, the processor 112 may receive one or more EV charging station reservation requests from one or more of the EVs. For example, the processor 112 may receive a first EV charging station reservation request associated with the first EV 130 at a first time slot, a second EV charging station reservation request associated with the second EV 140 at a second time slot, etc. The EV charging station reservation requests may be made by EVs which are not necessarily present at the EV charging station 110. Sometimes, EVs may make the EV charging station reservation request after arrival at the EV charging station 110 in a ‘walk-in’ type fashion. According to other aspects, other EVs may not be associated an EV charging station reservation request.

The processor 112 of the system 100 may monitor one or more aspects associated with one or more of the EVs. For example, the processor 112 may monitor an estimated arrival time associated with the first EV 130 and an estimated arrival time associated with the second EV 140. As another example, the processor 112 may monitor a location associated with the first EV 130 and a location associated with the second EV 140 when the GPS 172 of the corresponding EV transmits GPS information associated with the corresponding EV to the system 100. GPS information may include route information associated with the EV, estimated arrival times, an estimated distance 134 to the EV charging station 110, number of stops along the way, the nature of the stops, traffic along the routes, anticipated traffic along the routes, etc.

According to one aspect, if equipped, the GPS 172 of the EVs 130 may provide the communication interface 118 of the system 100 for EV charging station management with the corresponding location associated with each EV or the corresponding estimated arrival time associated with each EV. In this scenario, the location associated with the first EV 130 may be received from the GPS 172 of the first EV 130, the location associated with the second EV 140 may be received from the GPS of the second EV 140, etc.

As discussed above, the processor 112 may receive or monitor one or more aspects associated with one or more of the EVs and update one or more of the EV charging station reservations or an EV charging station schedule based on one or more of the monitored aspects associated with one or more of the EVs. Additionally, the processor 112 may prioritize the EV charging station reservations based on one or more of the monitored aspects associated with one or more of the EVs. Ultimately, the processor 112 may enable or disable charging for the EVs based on the EV charging station reservations. For example, the processor 112 may enable or disable charging for the first EV 130 based on the first EV charging station reservation and/or presence information or the location associated with the first EV 130.

The processor 112 may update or reschedule the EV charging station reservations or prioritize the EV charging station reservations according to one or more of the monitored aspects associated with one or more of the EVs differently across a wide variety of scenarios. For example, the processor 112 may prioritize the EV charging station reservations based on the locations of the EVs, the estimated arrival times associated with the EVs, a first received EV charging station reservation request, historical on-time EV charging station reservation attendance, whether or not the EV has an associated EV charging station reservation request, etc.

Examples of updating or rescheduling the EV charging station reservations and prioritization of the EV charging station reservations will be described in greater detail below. For example, if the first EV 130 is located or positioned closer to the EV charging station 110 than the second EV 140, the processor 112 may update the first EV charging station reservation and the second EV charging station reservation such that the first EV charging station reservation is ahead of the second EV charging station reservation. In this way, EV charging station reservation management may be provided such that charging slots are efficiently filled. Similarly, if the first EV 130 has an estimated arrival time ahead of an estimated arrival time of the second EV 140, the processor 112 may update the first EV charging station reservation and the second EV charging station reservation such that the first EV charging station reservation is ahead of the second EV charging station reservation, even if the first EV 130 is located or positioned closer to the EV charging station 110 than the second EV 140. Therefore, according to this aspect, the processor 112 may weigh the estimated arrival time of the EVs heavier than the location of the EVs.

The processor 112 may receive metadata to supplement the estimated arrival time for vehicles. For example, if the first EV 130 is navigating to a grocery store (e.g., metadata associated with nature of stop) and then to the EV charging station 110, the stop at the grocery store may be utilized to calculate the estimated arrival time. Additionally, other factors, such as a length of a grocery list or a time of day or level of traffic associated with the store may be utilized to estimate the estimated arrival time for the corresponding EV. In this way, metadata associated with intermediary destinations may be utilized to facilitate EV charging station reservation management.

According to one aspect, the processor 112 may prioritize the EV charging station reservations in order of estimated arrival time for associated EVs. According to another aspect, the processor 112 may bin EVs into different bins, such as a first bin where the EVs are associated with no intermediary destinations, are already en route, and are within a threshold estimated arrival time, a second bin where the EVs are associated with intermediary destinations, a third bin where EVs are not yet en route, and a fourth bin where EVs are outside of the threshold estimated arrival time. The processor 112 may prioritize EVs from the first bin over EVs from the second bin for example. Further, EVs may be prioritized based on historical on-time EV charging station reservation attendance (e.g., whether or not drivers kept their EV charging appointments in the past).

In the event of a detour or when a corresponding EV has a change in estimated arrival time, the system 100 for EV charging station management may prioritize that EV over other EVs which do not have or do not yet have an associated EV charging station reservation request. In this way, reservations for EV charging stations may be fluid because a vehicle associated with a reservation may make a pit stop, a detour, or be delayed. According to one aspect, automatic time adjustments for EV charging station reservations may be made while maintaining priority or adjusting priority order for a delayed vehicle. In this regard, a delayed vehicle which is associated with a booked reservation may be automatically rescheduled in an efficient fashion.

For example, an initial distance may be calculated to the EV charging station 110, and GPS coordinates from the GPS 172 of the EV 130 may be fed to the system 100 for EV charging station management. The EV 130 may be assigned a set time for arriving at the EV charging station 110 and the user or driver of the EV 130 may confirm whether they wish to charge at the EV charging station 110. As the EV 130 approaches the EV charging station 110, some event may have occurred where the driver cannot make their scheduled time. For example, a car accident may have occurred or the user may have taken a detour. If the EV 130 is delayed, an adjustment may be made to the corresponding EV charging station reservation. The system 100 for EV charging station management may open the corresponding time slot and hold a subsequent time slot to re-reserve the EV charging station reservation for the corresponding EV in an automatic fashion. In this way, the EV charging station 110 may now accommodate another EV that did not necessarily make an EV charging station reservation and bump up others in the queue.

Notifications may be provided corresponding EVs via the display 174 in the EV 130. A new time notification may be provided after re-reserving the EV charging station 110 for the original EV. Similarly, an EV which requested the same time slot as the original EV, but was initially denied may be provided with a notification indicating that that time slot (or other associated time slots) are open for reservation.

According to one aspect, once the first EV 130 arrives, preference may be given to the first EV 130 over other EV's without EV charging station reservations or with EV charging station reservations made subsequent to the first EV charging station reservation. In a charging facility that can charge multiple EVs, the newer vehicle may be sent to another charging station if opened, or based on charge level associated with corresponding EVs. In one example, several EV charging stations may exist and priority may be given to the original vehicle that made the reservation to the EV charging station 110. If another charging station is not available, the newer or second EV 140 may be directed to a different, nearby EV charging station.

In any event, the processor 112 may update the first EV charging station reservation and the second EV charging station reservation based on the location of the first EV 130 and the location of the second EV 140, update the first EV charging station reservation and the second EV charging station reservation based on the estimated arrival time associated with the first EV 130 and the estimated arrival time associated with the second EV 140, prioritize the first EV charging station reservation and the second EV charging station reservation based on the estimated arrival time associated with the first EV 130 and the estimated arrival time associated with the second EV 140, prioritize the first EV charging station reservation and the second EV charging station reservation based on the location of the first EV 130 and the location of the second EV 140, prioritize the first EV charging station reservation and the second EV charging station reservation based on a first received EV charging station reservation request of the first EV charging station reservation request and the second EV charging station reservation request, prioritize the first EV charging station reservation and the second EV charging station reservation based on historical on-time EV charging station reservation attendance, prioritize the first EV charging station reservation and a third EV 150 based on the location of the first EV 130, a location of the third EV 150, and an estimated arrival time associated with the first EV 130, update or prioritize the first and second EV charging station reservation requests based on whether or not the third EV 150 has and associated EV charging station reservation request, etc.

In this way, the system 100 and methods for EV charging station reservation adjustment may be directed to scheduling a time for a charge, rescheduling at the station if an event occurs, and prioritizing that vehicle over others when the EV arrives. The EV charging station 110 may be a Direct Current Fast Charge (DCFC) station.

FIG. 2 is an exemplary component diagram of a system 100 for EV charging station management, according to one aspect. The EV charging station 110 may be in computer communication with a server, which may be utilized to implement the system 100. The server may include one or more components of the system 100, as discussed above, such as a processor 112, a memory 114, a storage drive 116, a communication interface 118, a bus 122, etc. In this way, the communication interface 118 of the EV charging station 110 may communicate with the server and one or more EVs, such as the first EV 130, the second EV 140, the third EV 150, the fourth EV 160, etc. Each one of the one or more EVs may include the controller 132 including the processor 162, the memory 164, the storage drive 166, the communication interface 168, the GPS 172, the display 174, the audio interface 176, and the CAN bus 178 communicatively coupling respective components within the EV. The communication interface 168 of the EV may be in computer communication with a mobile device and/or the communication interface 118 of the system 100. The mobile device may include a processor 262, a memory 264, a storage drive 266, a communication interface 268, a global positioning system (GPS) 272, a display 274, an audio interface 276, a microphone, and a bus 278 communicatively coupling respective components within the mobile device.

According to one aspect, EVs may be communicatively coupled with the mobile device. Because the mobile device may include its own GPS unit 272, if coupled to the EV, the GPS unit 272 of the mobile device may provide the communication interface 118 of the system 100 for EV charging station management with the corresponding location associated with the corresponding EV or the estimated arrival time associated with the corresponding EV. In this scenario, the location associated with the first EV 130 may be received from the GPS 272 of the mobile device communicatively coupled to the first EV 130, the location associated with the second EV 140 may be received from the GPS 272 of the mobile device communicatively coupled to the second EV 140, etc.

According to one aspect, the EV 130 may be prioritized 234 over other EVs 140, 150, 160 based on having made an EV charging station reservation request prior to the other EVs 140, 150, 160. Thus, even if EVs 140, 150, 160 are present, closer in distance to the EV charging station 110 or even have already booked a time slot, the EV 130 associated with the earliest known reservation may take priority and ‘bump’ the other EVs 140, 150, 160 down a slot, for example. In FIG. 2, EV 140 may have made a reservation prior to EV 130. EV 130 may have experienced some delays resulting it EV 130 missing its originally scheduled charging time slot. The system 100 may reschedule EV 130 over subsequent reservation requests from EVs 150, 160, according to one aspect.

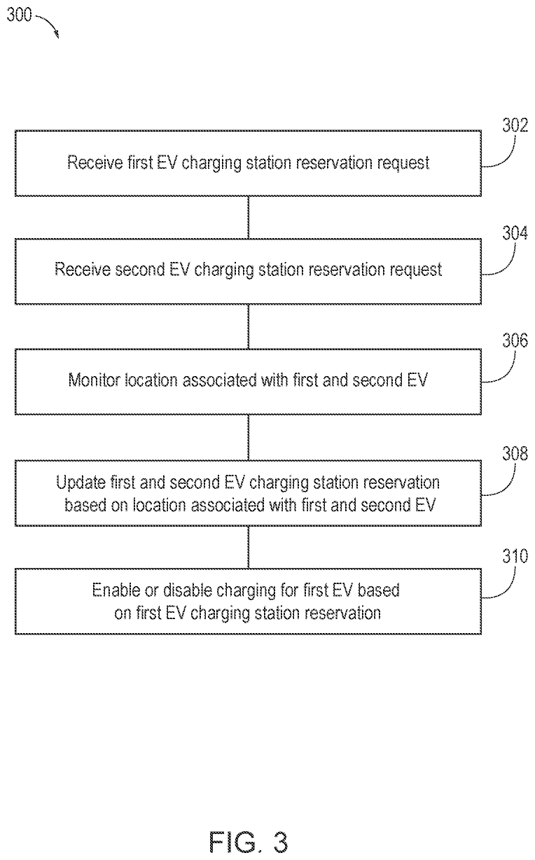

FIG. 3 is an exemplary flow diagram of a method 300 for electric vehicle (EV) charging station management, according to one aspect. The method 300 may include receiving 302 a first EV charging station reservation request associated with a first EV at a first time slot, receiving 304 a second EV charging station reservation request associated with a second EV at a second time slot, monitoring 306 a location associated with the first EV and a location associated with the second EV, updating 308 the first EV charging station reservation and the second EV charging station reservation based on the location of the first EV and the location of the second EV, and enabling or disabling charging 310 for the first EV based on the first EV charging station reservation.

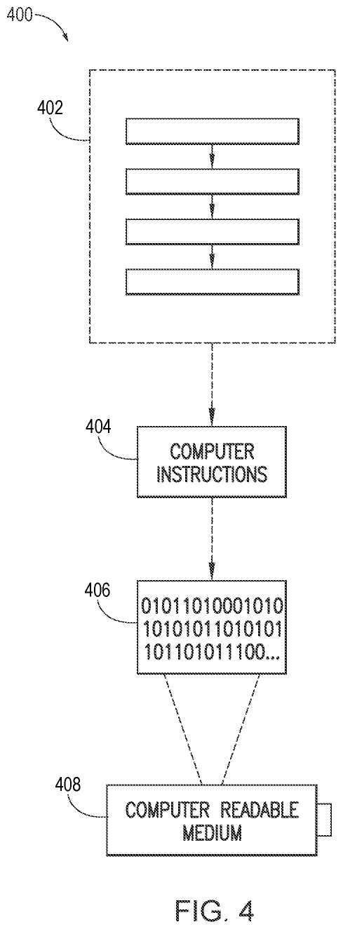

Still another aspect involves a computer-readable medium including processor-executable instructions configured to implement one aspect of the techniques presented herein. An aspect of a computer-readable medium or a computer-readable device devised in these ways is illustrated in FIG. 4, wherein an implementation 400 includes a computer-readable medium 408, such as a CD-R, DVD-R, flash drive, a platter of a hard disk drive, etc., on which is encoded computer-readable data 406. This encoded computer-readable data 406, such as binary data including a plurality of zero's and one's as shown in 406, in turn includes a set of processor-executable computer instructions 404 configured to operate according to one or more of the principles set forth herein. In this implementation 400, the processor-executable computer instructions 404 may be configured to perform a method 402, such as the method 300 of FIG. 3. In another aspect, the processor-executable computer instructions 404 may be configured to implement a system, such as the system 100 of FIG. 1 or the system 200 of FIG. 2. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

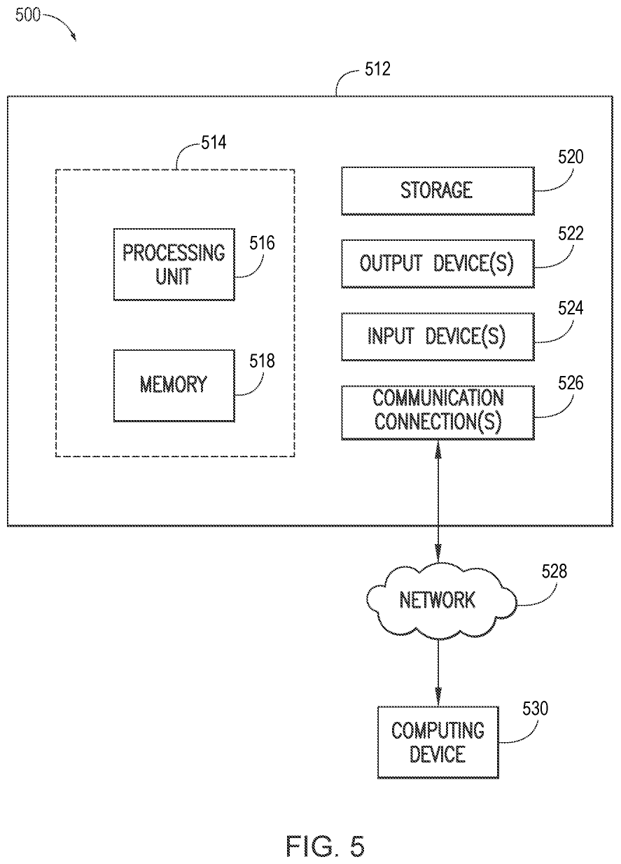

FIG. 5 and the following discussion provide a description of a suitable computing environment to implement aspects of one or more of the provisions set forth herein. The operating environment of FIG. 5 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 5 illustrates a system 500 including a computing device 512 configured to implement one aspect provided herein. In one configuration, the computing device 512 includes at least one processing unit 516 and memory 518. Depending on the exact configuration and type of computing device, memory 518 may be volatile, such as RAM, non-volatile, such as ROM, flash memory, etc., or a combination of the two. This configuration is illustrated in FIG. 5 by dashed line 514.

In other aspects, the computing device 512 includes additional features or functionality. For example, the computing device 512 may include additional storage such as removable storage or non-removable storage, including, but not limited to, magnetic storage, optical storage, etc. Such additional storage is illustrated in FIG. 5 by storage 520. In one aspect, computer readable instructions to implement one aspect provided herein are in storage 520. Storage 520 may store other computer readable instructions to implement an operating system, an application program, etc. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 512. Any such computer storage media is part of the computing device 512.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 512 includes input device(s) 524 such as keyboard, mouse, pen, voice input device, touch input device, infrared cameras, video input devices, or any other input device. Output device(s) 522 such as one or more displays, speakers, printers, or any other output device may be included with the computing device 512. Input device(s) 524 and output device(s) 522 may be connected to the computing device 512 via a wired connection, wireless connection, or any combination thereof. In one aspect, an input device or an output device from another computing device may be used as input device(s) 524 or output device(s) 522 for the computing device 512. The computing device 512 may include communication connection(s) 526 to facilitate communications with one or more other devices 530, such as through network 528, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for electric vehicle (EV) charging station management, comprising:
a memory storing instructions, which when executed by a processor, cause the processor to perform:
receiving a first EV charging station reservation request associated with a first EV at a first time slot;
receiving a second EV charging station reservation request associated with a second EV at a second time slot;
monitoring a location associated with the first EV and a location associated with the second EV;
updating the first EV charging station reservation and the second EV charging station reservation based on the location of the first EV and the location of the second EV; and
a controller enabling or disabling charging for the first EV based on the first EV charging station reservation.

2. The system for EV charging station management of claim 1, wherein the processor:
monitors an estimated arrival time associated with the first EV and an estimated arrival time associated with the second EV; and
updates the first EV charging station reservation and the second EV charging station reservation based on the estimated arrival time associated with the first EV and the estimated arrival time associated with the second EV.

3. The system for EV charging station management of claim 2, wherein the processor prioritizes the first EV charging station reservation and the second EV charging station reservation based on the estimated arrival time associated with the first EV and the estimated arrival time associated with the second EV.

4. The system for EV charging station management of claim 1, wherein the processor prioritizes the first EV charging station reservation and the second EV charging station reservation based on the location of the first EV and the location of the second EV.

5. The system for EV charging station management of claim 1, wherein the processor prioritizes the first EV charging station reservation and the second EV charging station reservation based on a first received EV charging station reservation request of the first EV charging station reservation request and the second EV charging station reservation request.

6. The system for EV charging station management of claim 1, wherein the processor prioritizes the first EV charging station reservation and the second EV charging station reservation based on historical on-time EV charging station reservation attendance.

7. The system for EV charging station management of claim 1, wherein the processor prioritizes the first EV charging station reservation and a third EV based on the location of the first EV, a location of the third EV, and an estimated arrival time associated with the first EV.

8. The system for EV charging station management of claim 7, wherein the third EV has no associated EV charging station reservation request.

9. The system for EV charging station management of claim 1, wherein the location associated with the first EV is received from a global positioning system (GPS) of the first EV.

10. The system for EV charging station management of claim 1, wherein the location associated with the first EV is received from a global positioning system (GPS) of a mobile device communicatively coupled with the first EV.

11. A method for electric vehicle (EV) charging station management, comprising:
receiving a first EV charging station reservation request associated with a first EV at a first time slot;
receiving a second EV charging station reservation request associated with a second EV at a second time slot;
monitoring a location associated with the first EV and a location associated with the second EV;
updating the first EV charging station reservation and the second EV charging station reservation based on the location of the first EV and the location of the second EV; and
enabling or disabling charging for the first EV based on the first EV charging station reservation.

12. The method for EV charging station management of claim 11, comprising:
monitoring an estimated arrival time associated with the first EV and an estimated arrival time associated with the second EV; and
updating the first EV charging station reservation and the second EV charging station reservation based on the estimated arrival time associated with the first EV and the estimated arrival time associated with the second EV.

13. The method for EV charging station management of claim 12, comprising prioritizing the first EV charging station reservation and the second EV charging station reservation based on the estimated arrival time associated with the first EV and the estimated arrival time associated with the second EV.

14. The method for EV charging station management of claim 11, comprising prioritizing the first EV charging station reservation and the second EV charging station reservation based on the location of the first EV and the location of the second EV.

15. The method for EV charging station management of claim 11, comprising prioritizing the first EV charging station reservation and the second EV charging station reservation based on a first received EV charging station reservation request of the first EV charging station reservation request and the second EV charging station reservation request.

16. The method for EV charging station management of claim 11, comprising prioritizing the first EV charging station reservation and the second EV charging station reservation based on historical on-time EV charging station reservation attendance.

17. The method for EV charging station management of claim 11, comprising prioritizing the first EV charging station reservation and a third EV based on the location of the first EV, a location of the third EV, and an estimated arrival time associated with the first EV.

18. The method for EV charging station management of claim 11, wherein the location associated with the first EV is received from a global positioning system (GPS) of the first EV.

19. The method for EV charging station management of claim 11, wherein the location associated with the first EV is received from a global positioning system (GPS) of a mobile device communicatively coupled with the first EV.

20. A system for electric vehicle (EV) charging station management, comprising:
a memory storing instructions, which when executed by a processor, cause the processor to perform:
receiving a first EV charging station reservation request associated with a first EV at a first time slot;
receiving a second EV charging station reservation request associated with a second EV at a second time slot;
monitoring an estimated arrival time associated with the first EV and an estimated arrival time associated with the second EV;
updating the first EV charging station reservation and the second EV charging station reservation based on the estimated arrival time associated with the first EV and the estimated arrival time associated with the second EV; and
a controller enabling or disabling charging for the first EV based on the first EV charging station reservation.
